(19) United States
(12) Patent Application Publication
(10) Pub. No.: US 2009/0077489 A1
(43) Pub. Date: Mar. 19, 2009

(54) Display control apparatus, method and program

(75) Inventor: Fuminori Homma, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/283,037

(22) Filed: Sep. 9, 2008

(30) Foreign Application Priority Data
Sep. 14, 2007 (JP) P2007-239732

(51) Int. Cl. G06F 3/048

(52) U.S. Cl. 715/788

(57) ABSTRACT

A display control apparatus includes video window display means for displaying digital video data, control panel window display means for displaying a control panel window on which the video window display means may be operated, select means for selecting the video window display means, active window display means for displaying an arbitrary application, alignment frame means for aligning the video window display means, and multiwindow display control means for controlling the display positions and sizes of the video window display means and control panel window display means.

### CROSS REFERENCES TO RELATED APPLICATIONS

The present invention contains subject matter related to Japanese Patent Application JP 2007-239732 filed in the Japanese Patent Office on Sep. 14, 2007, the entire contents of which being incorporated herein by reference.

### BACKGROUND OF THE INVENTION

1. Field of the Invention

The present invention relates to a display control apparatus, method and program, and it particularly relates to a display control apparatus, method and program that allow properly creating a window, changing a window size and laying out a window, for example, under the control over multiwindow display, which is a screen display format for use in a computer system.

2. Description of the Related Art

In recent years, use cases that play moving picture contents on a PC application have been widely spread because of the increase in speed of networks, the rapid spread of PCs (or personal computers) or the like to general households and the improve in image quality of PC monitors.

Particularly, the widely spread use cases may include not only an “active viewing” case in which applicable moving picture contents obtained by downloading it from a server over the Internet as in the past is viewed actively but also a “passive viewing” case in which an external AV machine owned by a user continuously plays TV broadcast contents by using a technology for streaming on a PC application, for example, over the Internet.

In the latter “passive viewing” case particularly, a user may sometimes use a multiwindow system by which multiple windows can be displayed simultaneously on a PC application to continuously play moving picture contents on one window and perform other works, such as net-surfing, on another window such as an Internet browser. In this case, the usages may be considered in which bit times are mutually complemented by using one window during the waiting time (such as a CM time on a TV and a loading time during net-surfing) on the other window or, conversely, by stopping the use of one window when attractive contents is shown on the other window.

A multiwindow system generally has a characteristic that an active window is always displayed to the forefront. Therefore, in a case of “passive viewing”, a window playing moving picture contents and a window on which a different work is performed, such as net-surfing on an Internet browser, may be placed one over another. Every time when the necessity rises for displaying the currently hidden window to the forefront and activating it, a user has to perform an operation of clicking on the hidden window with a mouse.

Even during the manual adjustment of the layout of windows by a user for avoiding the overlap of the windows, it is also necessary to perform an operation of moving one window to an unoverlapped area every time the other window is moved.

Since it is stressful for a user to frequently and continuously perform those operations every bit times when the overlap of windows occurs, seamless and intuitive operations are important for repetitively performing the operations.

Accordingly, JP-A-2002-116903 (Patent Document 1) and JP-A-2001-331165 (Patent Document 2) propose methods for avoiding the overlap of windows.

### SUMMARY OF THE INVENTION

However, in those proposals, first of all, the access right on the operating system level is important, and it is difficult to apply those proposals to a case where operations on other windows are inhibited or limited, as on a PC application. Second, those proposals only mechanically perform layout adjustment on windows and may be poor to produce simple and intuitive images such as an image in which other monitor is internally contained on a PC monitor.

Accordingly, it is desirable to provide a system, which is specific to “zapping” of moving picture contents performed on a PC, can be implemented with a PC application alone and automates intuitive and stable layout adjustment of multiple windows.

According to an embodiment of the present invention, there is provided a display control apparatus including video window display means for displaying digital video data, control panel window display means for displaying a control panel window on which the video window display means may be operated, select means for selecting the video window display means, active window display means for displaying an arbitrary application, alignment frame means for aligning the video window display means, and multiwindow display control means for controlling the display positions and sizes of the video window display means and control panel window display means.

According to another embodiment of the invention, there is provided a display control method in a display control apparatus or a program for a display control apparatus, the apparatus having a video window display unit displaying digital video data, a control panel window display unit displaying a control panel window on which the video window display unit may be operated, a select unit selecting the video window display unit, an active window display unit displaying an arbitrary application and an alignment frame unit aligning the video window display unit, the method or program including a multiwindow display control step of controlling the display positions and sizes of the video window display unit and control panel window display unit.

In the display control apparatus, display control method and program according to the embodiments of the invention, there are provided a video window display unit displaying digital video data, a control panel window display unit displaying a control panel window on which the video window display unit may be operated, a select unit selecting the video window display unit, an active window display unit displaying an arbitrary application and an alignment frame unit aligning the video window display unit, and the display positions and sizes of the video window display unit and control panel window display unit are controlled.

According to the embodiments of the invention, in order to automatically adjust the layout of a video window display unit that plays moving picture contents, control panel display unit therefor and active window display unit that displays a currently operating arbitrary application, an intuitive and stable multiwindow layout system, which is completed on a PC application alone, is provided, whereby the stress caused by continuous passive viewing of moving picture contents on a PC can be reduced. The screen display, which is easy to see and reflecting a user's intension, is further provided, and a user's intension can be reflected to the determination on the window layout to an extent that user's operations are not too complicated.

### BRIEF DESCRIPTION OF THE DRAWINGS

FIG. 1 is a diagram showing a configuration example of a streaming system that applies an embodiment of the invention;

FIG. 2 is a block diagram showing a configuration example of a client machine 13 in FIG. 1;

FIG. 3 is a diagram showing a display example of windows in multiwindow display control processing;

FIG. 4 is a diagram showing another display example of windows in the multiwindow display control processing;

FIG. 5 is a diagram showing another display example of windows in the multiwindow display control processing;

FIG. 6 is a diagram showing another display example of windows in the multiwindow display control processing;

FIG. 7 is a diagram showing another display example of windows in the multiwindow display control processing;

FIG. 8 is a diagram showing another display example of windows in the multiwindow display control processing;

FIG. 9 is a diagram showing another display example of windows in the multiwindow display control processing; and

FIG. 10 is a flowchart describing the multiwindow display control processing.

### DESCRIPTION OF THE PREFERRED EMBODIMENTS

Embodiments of the invention will be described below where the correspondence between constituent features of the invention and embodiments described in the specification or drawings will be illustrated as follows. This description is for confirming that embodiments supporting the invention are described in the specification or drawings. Therefore, the existence of an embodiment described in the specification or drawings but not described herein as an embodiment corresponding to a constituent feature of the invention does not mean that the embodiment does not correspond to the constituent feature. Conversely, the existence of an embodiment described herein as one corresponding to a constituent feature does not means that the embodiment does not correspond to other constituent features excluding the constituent feature.

A display control apparatus according to an embodiment of the invention includes:

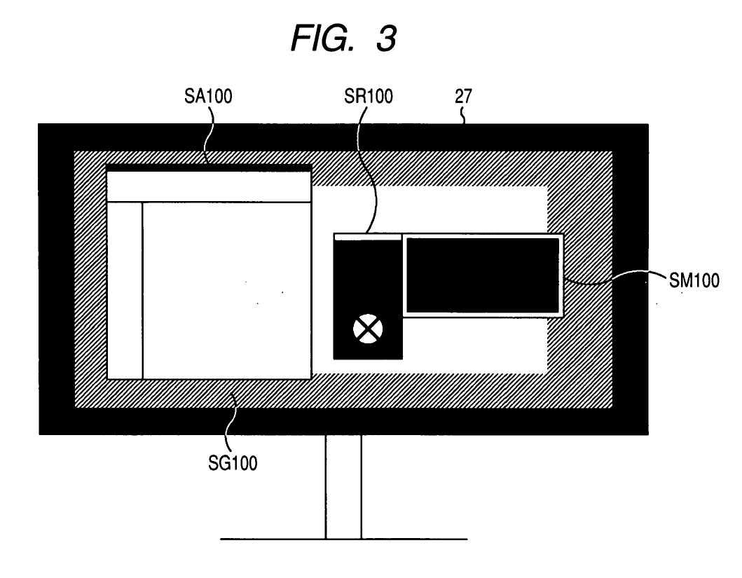

video window display means (such as a video window SM100 in FIG. 3) for displaying digital video data;

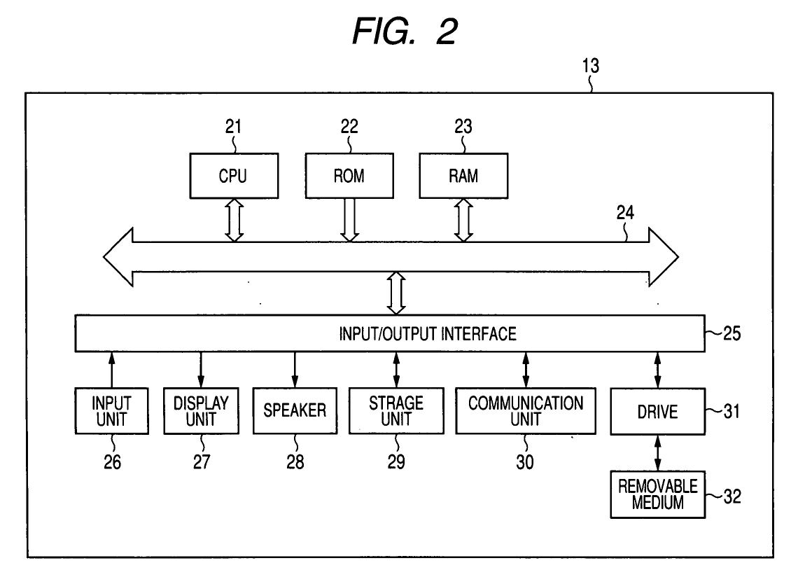

control panel window display means (such as a CPU 21 in FIG. 2) for displaying a control panel window (such as a control panel SR100 in FIG. 3) on which the video window display means may be operated;

select means (such as the CPU 21 in FIG. 2) for selecting the video window display means;

active window display means (such as an active window SA100 in FIG. 3) for displaying an arbitrary application;

alignment frame means (such as an alignment frame unit SG100 in FIG. 3) for aligning the video window display means; and

multiwindow display control means (such as the CPU 21 in FIG. 2) for controlling the display positions and sizes of the video window display means and control panel window display means.

With reference to drawings, embodiments applying the invention will be described below.

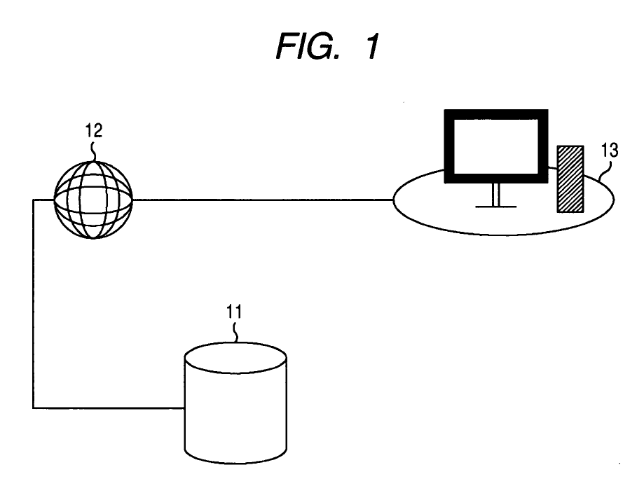

FIG. 1 shows a configuration example of a streaming system applying an embodiment of the invention. A streaming server 11 may hold contents (such as an MPEG file and a TV broadcast signal) to be played and provide it to a client machine 13 such as a PC over communication means 12 such as the Internet. The client machine 13 receives contents provided from the streaming server 11 over the communication means 12 and streams it.

FIG. 2 shows a configuration example of the client machine 13.

A CPU (Central Processing Unit) 21, a ROM (Read Only Memory) 22 and a RAM (Random Access Memory) 23 are mutually connected via a bus 24.

An input/output interface 25 further connects to the bus 24. The input/output interface 25 connects to an input unit 26 including a keyboard, a mouse and a microphone, for example, a display unit 27 such as a display, a speaker 28, a storage unit 29 including a hard disk and a non-volatile memory, for example, a communication unit 30 including a network interface, for example, and a drive 31 that drives a removable medium 32 such as a magnetic disk, an optical disk, a magneto-optical disk and a semiconductor memory.

In the client machine 13 having the configuration above, the CPU 21 may load and execute a program stored in the storage section 29 through the input/output interface 25 and via the bus 24 to the RAM 23, for example, to decrypt, decode and render the streaming data received by the communication unit 30 over the communication means 12. Then, the resulting pictures may be displayed on the display unit 27, and/or resulting sound is output through the speaker 28. Multiwindow display control processing, which will be described later, will be further executed thereby.

The program to be executed by the CPU 21 may be recorded and provided on a removable medium 32 or through a wired or wireless transmission medium such as a local area network, the Internet and digital satellite broadcasting.

Then, by attaching the removable medium 32 to the drive 31, the program may be installed to the storage unit 29 through the input/output interface 25. Alternatively, the program may be received by the communication unit 30 through a wired or wireless transmission medium and be installed in the storage unit 29. Alternatively, the program may be pre-installed in the ROM 22 or the storage unit 29.

The program to be executed by a computer may be a program to be processed in a time series manner by following steps described herein or may be a program to be processed in parallel or at a time when invoked, for example.

Next, with reference to FIG. 3, screen arrangement relating to the multiwindow display control processing in the client machine 13 will be described.

A video window SM100 to be displayed on the display unit 27 of the client machine 13 is a window that plays moving picture contents, which is received from the streaming server 11. A control panel SR100 is a panel window to be operated for controlling the playback of moving picture contents on the video window SM100. A user may use the control panel SR100 to mainly control the streaming of contents. The control panel SR100 is integrated to the video window SM100 herein though the control panel SR100 may be integrated to or separated from the video window SM100 to move.

An active window SA100 is a window, such as an Internet browser, on which a user is currently performing a different operation by using the client machine 13. An alignment frame unit SG100 is an area that displays the aligned video window SM100.

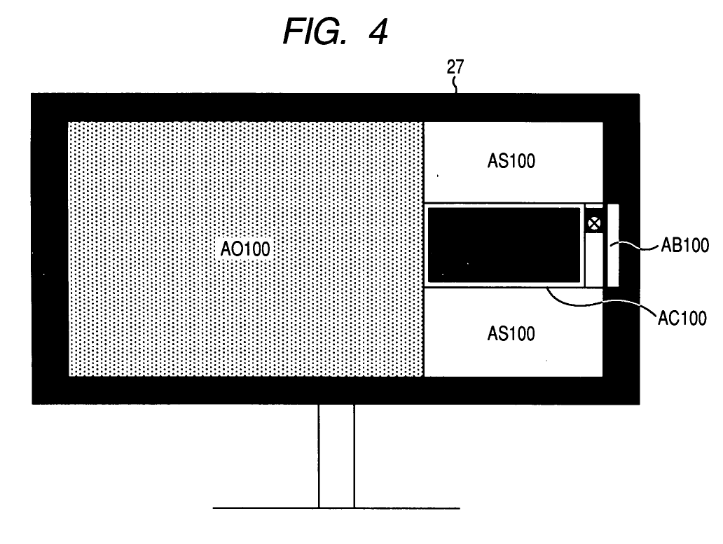

Next, with reference to FIG. 4, the definitions of display areas will be described, which are important for describing the multiwindow display control processing.

An area AC100 is a video window area where the video window SM100 is displayed, and an area AB100 is a contact area in contact with the area AC100. An area AS100 is a side area of the video window area AC100, which is orthogonal to the contact area AB100, and an area AO100 is an opposite area, which is positioned on the opposite side of the contact area AB100 across the video window area AC100.

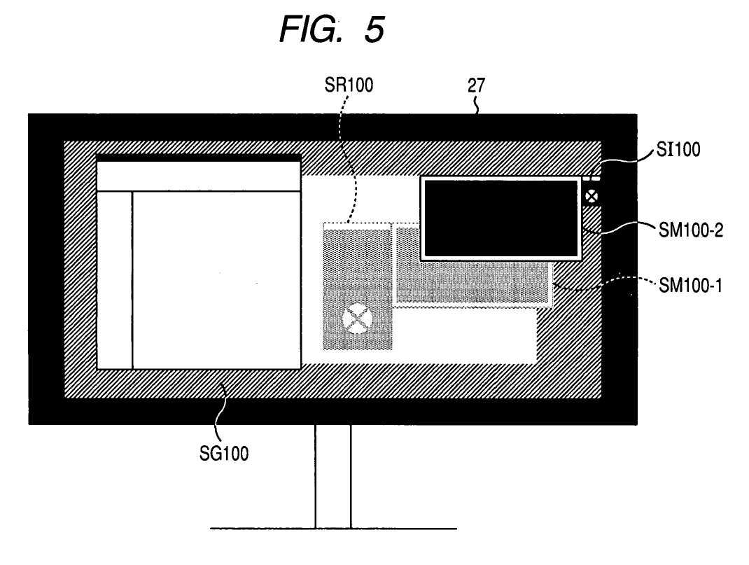

Next, with reference to FIGS. 5 to 9, the concept of the multiwindow display control processing in the client machine 13 will be described.

In a case where the video window SM100, control panel SR100 and active window SA100 are displayed as shown in FIG. 3, for example, a user may operate a mouse, not shown, to drag the video window SM100, whereby the alignment frame unit SG100 is displayed.

Then, when a user may operate the mouse to drop the video window SM100 (which results in the video window SM100-1) to the alignment frame unit SG100 as shown in FIG. 5, the video window SM100 is automatically aligned at a predetermined specific position in the alignment frame unit SG100 (which results in the video window SM100-2). The control panel SR100 in this case is iconized to a control panel icon SI100 at the upper right of the video window SM100 aligned on the alignment frame unit SG100.

The numbers given to the reference numerals of windows and the like after a hyphen shown in FIGS. 5 to 9 are for description of changes in display forms of windows, for example. The lightly rendered parts and parts with dashed lines illustrate windows before the change in display form, for example.

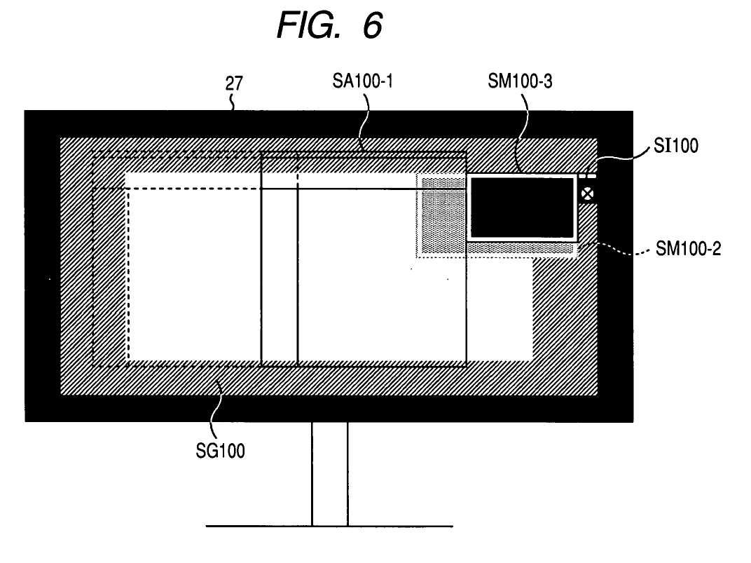

Next, by moving the active window SA100 (which results in the active window SA100-1) over the video window SM100 (which is the video window SM100-2) aligned on the alignment frame unit SG100, as shown in FIG. 6, the video window SM100 in this example (that is, in the example that the video window SM100 is touched from the left side) is reduced about the right frame (which results in the video window SM100-3). If the video window SM100 is touched from the left side as in the example, the control panel icon SI100 at the upper right of the video window SM100 holds the display state.

Next, the display control over the iconized control panel SR100 will be described.

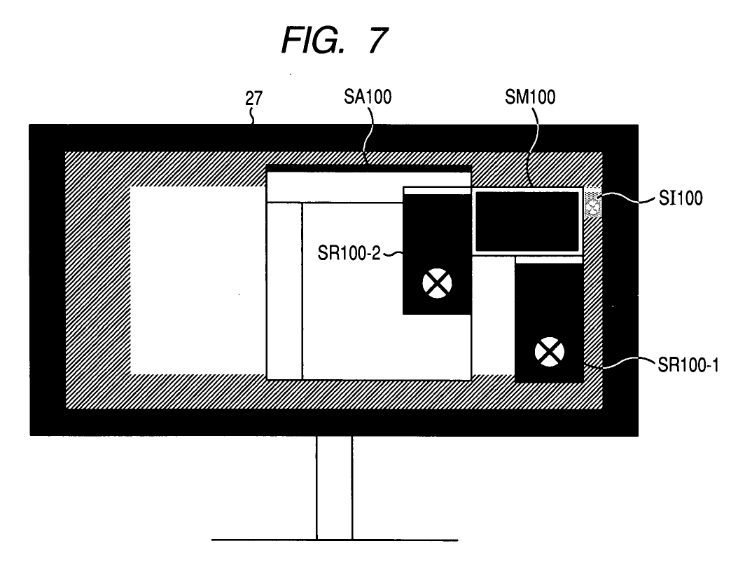

For example, the control panel icon SI100 shown in FIG. 6 is returned to the original size after a lapse of an arbitrary time (such as several seconds) after mouseover by a mouse operation by a user as shown in FIG. 7, whereby the control panel SR100 is displayed. The position where the control panel SR100 is to be displayed may be in the side area AS100 if any area to display is available in the side area AS100 (which results in the control panel SR100-1). If no space to display is available in the side area AS100, the control panel SR100 is displayed on the opposite area AO100. Since a user may perform an operation on the control panel SR100 as the highest priority, the control panel SR100 is displayed on the active window SA100 (which results in the control panel SR100-2). If no space to display is available in the opposite area AO100 either, the control panel SR100 is displayed on the video window SM100.

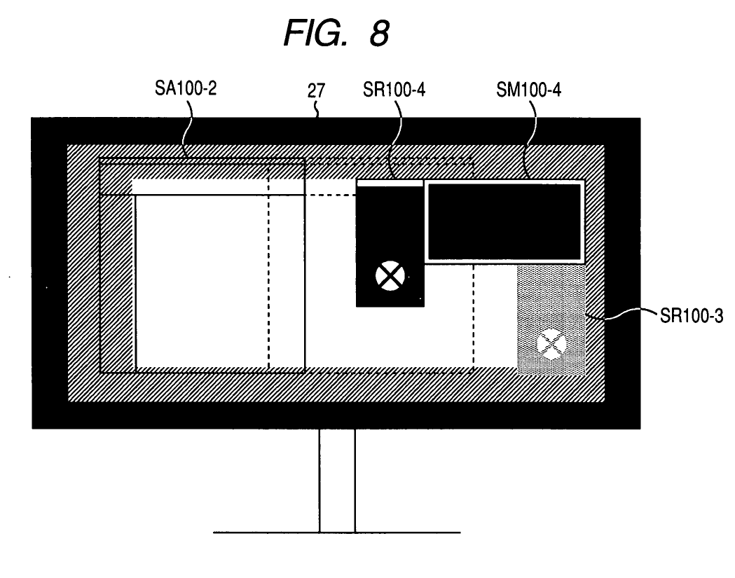

Next, a case will be described where a user operates the mouse to move the active window SA100 in contact with the video window SM100 as shown in FIG. 7 (and FIG. 6) away from the video window SM100 (which results in the active window SA100-2), as shown in FIG. 8. In this case, the video window SM100 returns to the original size (which results in the video window SM100-4). If the control panel SR100 is displayed on the side area AS100 here, the display space of the control panel SR100 is checked again. If no space is available in the side area AS100 (which results in the control panel SR100-3), the control panel SR100 is automatically displayed on the opposite area AO100 (which results in the control panel SR100-4).

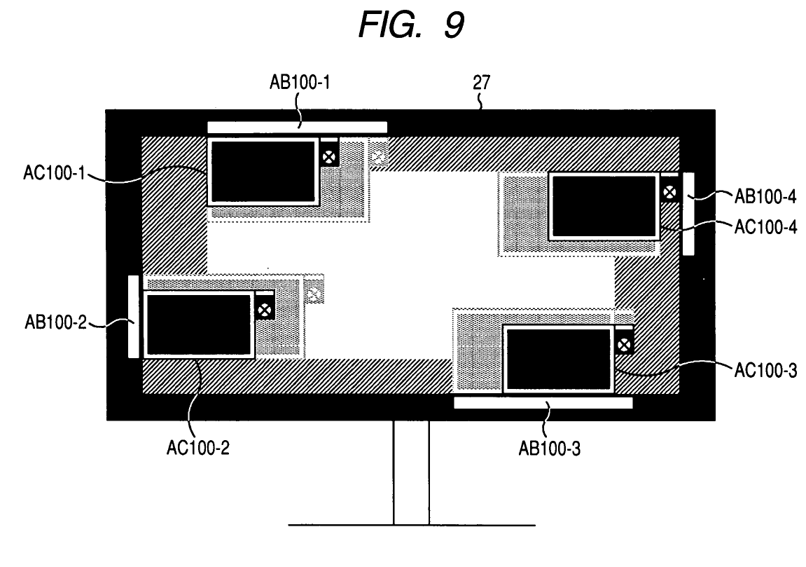

FIG. 9 shows display operations on the video window SM100 in a case where the behaviors above are performed about the top, down, left and right frames. In common operations, if the video window SM100 is touched from contact area AB100-1, AB100-2, AB100-3 or AB100-4 or the opposite side (opposite area), the video window SM100 is simply reduced. If it is touched from the side area in contact, the video window SM100 is reduced with respect to the opposite side with the contact part fixed (which results in the video window area AC100-1, AC100-2, AC100-3 or AC100-4).

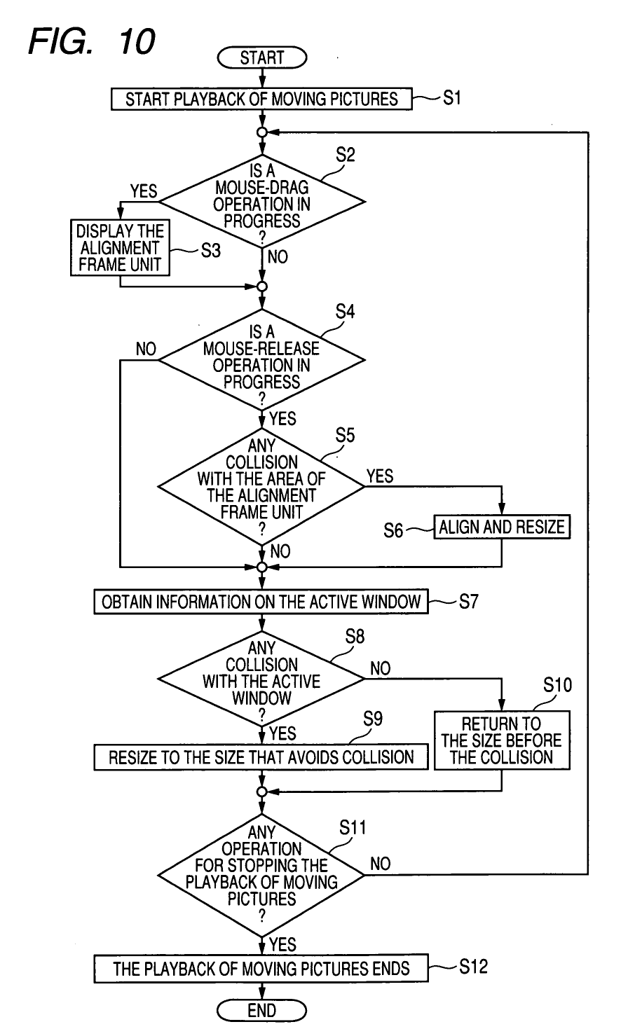

Next with reference to the flowchart in FIG. 10, the video window display control processing will be described.

In step S1, the client machine 13 plays applicable moving picture contents on the video window SM100.

In step S2, the client machine 13 determines whether a user is performing a mouse-drag operation on the video window SM100 or not. If it is determined that the mouse-drag operation is progress, the processing moves to step S3 where the alignment frame unit SG100 is displayed.

In step S4, the client machine 13 determines whether a user is operating a mouse-release operation on the video window SM100 or not.

If it is determined in step S4 that the mouse-release operation is in progress, the client machine 13 in step S5 determines whether the video window SM100 and the area of the alignment frame unit SG100 are colliding with each other or not. If it is determined so, the video window SM100 is automatically aligned (or aligned and resized) at a predetermined specific position in the alignment frame unit SG100 in step S6.

Next in step S7, the client machine 13 obtains the display information on the active window SA100.

In step S8, the client machine 13 determines whether the active window SA100 and the video window SM100 collide with each other or not based on the obtained display information. If it is determined so, the video window SM100 is resized to the size that avoids the collision with the active window SA100 in step S9. If it is determined not, the video window SM100 is returned to the size before the collision in step S10.

After the processing in step S9 or S10, the client machine 13 in step S11 determines whether an operation of stopping the playback of moving pictures has been performed by a user or not. If it is determined so, the playback of moving pictures ends in step S12. If it is determined not on the other hand, the processing returns to step S2, and the subsequent processing is performed in the same manner.

As described above, since an intuitive and stable multiwindow layout system, which is completed with a PC application alone, is provided, the stress for continuously performing the passive viewing of moving picture contents on a PC can be reduced. Furthermore, since easy-to-see screen display is provided that reflects a user's intension, a user's intension can be reflected to the determination on the window layout to the extent that the user's operations are not too complicated.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus comprising:
video window display means for displaying digital video data;
control panel window display means for displaying a control panel window on which the video window display means may be operated;
select means for selecting the video window display means;
active window display means for displaying an arbitrary application;
alignment frame means for aligning the video window display means; and
multiwindow display control means for controlling the display positions and sizes of the video window display means and control panel window display means.

2. A display control method in a display control apparatus having
a video window display unit displaying digital video data,
a control panel window display unit displaying a control panel window on which the video window display unit may be operated,
a select unit selecting the video window display unit,
an active window display unit displaying an arbitrary application, and
an alignment frame unit aligning the video window display unit,
the method comprising the step of:
controlling the display positions and sizes of the video window display unit and control panel window display unit.

3. A program for display control in a display control apparatus, the apparatus having
a video window display unit displaying digital video data,
a control panel window display unit displaying a control panel window on which the video window display unit may be operated,
a select unit selecting the video window display unit,
an active window display unit displaying an arbitrary application, and
an alignment frame unit aligning the video window display unit,
the program causing the display control apparatus to perform processing comprising the step of:
controlling the display positions and sizes of the video window display unit and control panel window display unit.

4. A display control apparatus comprising:
a video window display unit configured to display digital video data;
a control panel window display unit configured to display a control panel window on which the video window display unit may be operated;
a select unit configured to select the video window display unit;
an active window display unit configured to display an arbitrary application;
an alignment frame unit configured to align the video window display unit; and
a multiwindow display control unit configured to control the display positions and sizes of the video window display unit and control panel window display unit.
